(19) United States
(12) Patent Application Publication
(10) Pub. No.: US 2007/0138385 A1
(43) Pub. Date: Jun. 21, 2007

(54) Time-of-flight secondary ion mass spectrometer mapping of cells and tissue

(75) Inventors: Kristen S. Kulp, Livermore, CA (US); Kuang Jen J. Wu, Cupertino, CA (US); Mark G. Knize, Tracy, CA (US); James S. Felton, Danville, CA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/633,997

(22) Filed: Dec. 4, 2006

Related U.S. Application Data
(60) Provisional application No. 60/742,589, filed on Dec. 5, 2005.

(51) Int. Cl. B01D 59/44

(52) U.S. Cl. 250/282

(57) ABSTRACT

A method of analyzing a cell. A finely focused energetic primary-ion beam of a time-of-flight secondary ion mass spectrometer is directed to the cell. Interrogating at least one region of interest area from the cell and producing data. Distributing the data in plots indicating measures of similarity.

### CROSS-REFERENCE TO RELATED APPLICATIONS

This application claims the benefit of U.S. Provisional Patent Application No. 60/742,589 filed Dec. 5, 2005 and titled “Research and Diagnostic Use of Mass Spectrometry.” Provisional Patent Application No. 60/742,589 filed Dec. 5, 2005 and titled “Research and Diagnostic Use of Mass Spectrometry” is incorporated herein by this reference.

The United States Government has rights in this invention pursuant to Contract No. W-7405-ENG48 between the United States Department of Energy and the University of California for the operation of Lawrence Livermore National Laboratory.

### BACKGROUND

1. Field of Endeavor

The present invention relates to mapping of cells and tissue and more particularly to mass spectrometer system of mapping of cells and tissue.

2. State of Technology

U.S. Pat. No. 5,808,300 for a method and apparatus for imaging biological samples with MALDI MS, issued Sep. 15, 1998 to Richard M. Caprioli and assigned to Board of Regents, The University of Texas System provides the following state of technology information: “The combination of capillary electrophoresis (CE) and mass spectrometry (MS) provides an effective technique for the analysis of femtomole/attomole amounts of proteins and peptides. The low load levels and high separation efficiency of capillary electrophoresis are well suited to the mass measurement capability and high sensitivity of mass spectrometry. A considerable amount of work has been published using electrospray mass spectrometry for on-line coupling to capillary electrophoresis.”

U.S. Pat. No. 6,756,586 for methods and apparatus for analyzing biological samples by mass spectrometry, issued Jun. 29, 2004 to Richard M. Caprioli and assigned to Vanderbilt University provides the following state of technology information: “A specimen is generated, which may include an energy absorbent matrix. The specimen is struck with laser beams such that the specimen releases proteins. The atomic mass of the released proteins over a range of atomic masses is measured. An atomic mass window of interest within the range of atomic masses is analyzed to determine the spatial arrangement of specific proteins within the sample, and those specific proteins are identified as a function of the spatial arrangement. By analyzing the proteins, one may monitor and classify disease within a sample.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a method of analyzing single cells, small groups of cells or a single cell within tissues or surrounding materials. A finely focused energetic primary-ion beam of a time-of-flight secondary ion mass spectrometer is directed to the small groups of cells or the single cell and tissues or surrounding materials. At least one region of interest is interrogated and data is produced. The at least one region of interest can be an area from individual cells, tissues or surrounding materials. The data is distributed in plots indicating measures of similarity.

In one embodiment the present invention employs time-of-flight secondary ion mass spectrometry (ToF-SIMS) to detect markers for normal and cancerous cells, identify markers of damage that are indicative of disease progression, and categorize the tissue origin of a specific cell. One embodiment includes obtaining data from a sample and comparing the data with known data to characterize disease phenotype of the small groups of cells, the single cell, or the tissues or surrounding materials and predict disease outcome.

The present invention can be used for medical diagnostic and prognostic applications. Embodiments of the present invention involve individual eukaryotic cells and multicellular tissues. The present invention can be used clinically to complement typical pathological diagnoses that rely on morphologic assessment. Characterization of abnormal cells or tissues can be used to identify early markers of disease or predict the course of the disease.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates one embodiment of a method of the present invention.

FIG. 2 illustrates another embodiment of a method of the present invention.

FIGS. 3A, 3B, 3C, and 3D are scores plots.

FIGS. 4A, 4B, 4C, and 4D are scores and loading plots.

FIGS. 5A, 5B, and 5C illustrate how the optical images are used to facilitate localization of the ToF-SIMS images.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

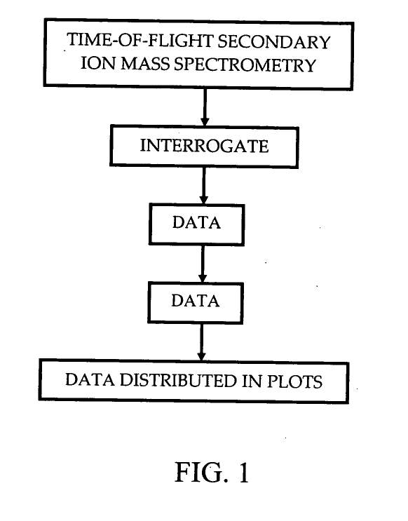

Referring now to the drawings and in particular to FIG. 1, one embodiment of a method of the present invention is illustrated. The method is designated generally by the reference numeral 100. The method 100 provides is a method of analyzing small groups of cells or a single cell with tissues or surrounding materials. The method 100 includes a series of steps.

In step 101 a finely focused energetic primary-ion beam of a time-of-flight secondary ion mass spectrometry beam is direct to the small groups of cells or the single cell and tissues or surrounding materials. The finely focused energetic primary-ion beam is produced by a time-of-flight secondary ion mass spectrometry (ToF-SIMS).

In step 102 at least one region of interest is interrogated. The at least one region of interest can be an area from individual cells, tissues or surrounding materials. In step 103 data is produced. In step 104 the data is distributed in plots indicating measures of similarity.

The plots are used to detect markers for normal and cancerous cells, identify markers of damage that are indicative of disease progression, and categorize the tissue origin of a specific cell. The method 100 can be used for medical diagnostic and prognostic applications. Embodiments of the present invention involve individual eukaryotic cells and multicellular tissues. The present invention can be used clinically to complement typical pathological diagnoses that rely on morphologic assessment. Characterization of abnormal cells or tissues can be used to identify early markers of disease or predict the course of the disease.

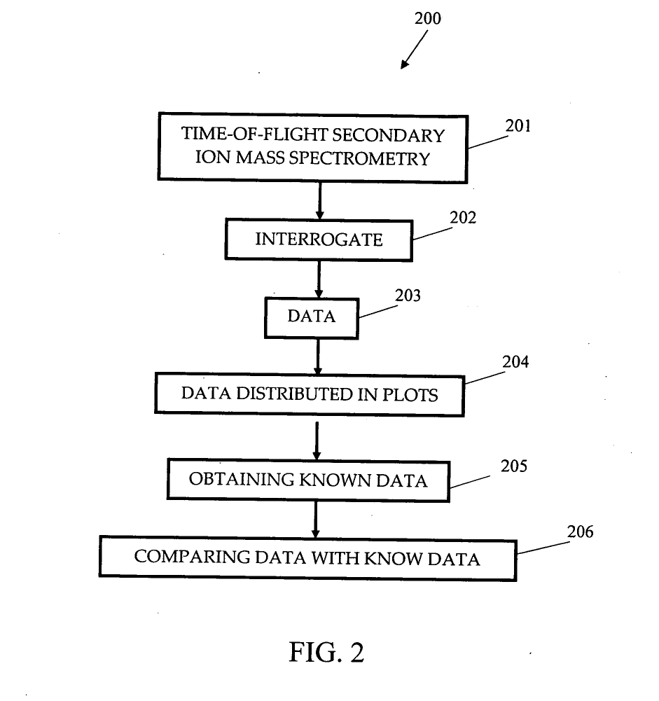

Referring now to FIG. 2, another embodiment of a method of the present invention is illustrated. This embodiment is designated generally by the reference numeral 200.

The method 200 provides is a method of analyzing small groups of cells or a single cell with tissues or surrounding materials. The method 200 includes a series of steps. In step 201 a finely focused energetic primary-ion beam of a time-of-flight secondary ion mass spectrometer is directed to the small groups of cells or the single cell and tissues or surrounding materials. In step 202 at least one region of interest is interrogated. The at least one region of interest can be an area from individual cells, tissues or surrounding materials. In step 203 data is produced. In step 204 the data is distributed in plots indicating measures of similarity. In step 205 known data is obtained. In step 206 the data is compared with the known data to characterize disease phenotype of the small groups of cells, the single cell, or the tissues or surrounding materials and predict disease outcome.

The method 200 can be used for medical diagnostic and prognostic applications. Embodiments of the present invention involve individual eukaryotic cells and multicellular tissues. The present invention can be used clinically to complement typical pathological diagnoses that rely on morphologic assessment. Characterization of abnormal cells or tissues can be used to identify early markers of disease or predict the course of the disease.

### EXAMPLES

Formalin-fixed paraffin-embedded (FFPE) tumor samples are routinely used for disease diagnosis and are one of the most important and most abundant sources of clinical samples available in medical centers and medical schools. New technologies for analyzing these samples that can be used to improve tissue-based diagnosis, predict response to specific modes of treatment, and aid in prognosis decisions will greatly improve decisions about therapeutic strategies.

Beyond the conventional histopathological methods, little has been done to develop new methods to analyze FFPE tissues. No studies have been done to investigate the distribution of small molecules in FFPE tissues. Applicants have used bioimaging time-of-flight secondary ion mass spectrometry (ToF-SIMS) to image tissues by their secondary ions in deparaffinized mouse embryo sections. Applicants then differentiated these tissues based on differences in small molecules remaining after paraffin-imbedding and fragments of the tissue proteins. These experiments serve as a preliminary study for further investigation of human FFPE samples from tumor and normal tissues.

Time-of-Flight Secondary Ion Mass Spectrometry (ToF-SIMS) is a surface sensitive technique that allows the detection and localization of the chemical composition of sample surfaces. The instrument uses a finely focused (˜300 nm), pulsed primary ion beam to desorb and ionize molecular species from a sample surface. The resulting secondary ions are accelerated into a mass spectrometer, where they are analyzed for mass by measuring their time-of-flight from the sample surface to the detector. Displaying the mass spectra that were collected from the sample surface generates chemical images. The resulting ion images contain a mass spectrum in each pixel of the 256×256 pixels in an image. These mass spectra are used to create secondary ion images that reflect the composition and distribution of sample surface constituents.

Principal Component Analysis (PCA) is an example of one type of data reduction technique that can be used to identify similarities and differences in ToF-SIMS spectra and classify spectra into groups. PCA is a standard, unsupervised multivariate statistical technique, which reduces a large data matrix to a few manageable variables called principal components (PCs). Principal components represent linear combinations of the original data and capture the greatest variation in the data set. By plotting the resulting ‘scores’ and ‘loading’ plots, the relationship between samples and variables can be visualized and easily interpreted. Applicants have shown that ToF-SIMS imaging and PCA can differentiate whole cells and homogenates of three carcinoma-derived human breast cancer cell lines (MCF-7, T47D and MDA-MB-231).

Other data reduction techniques, such as linear discriminant analysis (LDA), Partial Least Squares discriminant analysis (PLSDA), Hierarchical Clustering and Recursive Partitioning can be used to analyze ToF-SIMS data. For understanding prognostic markers in the cells, groups of cells, or tissues, machine learning techniques like Decision Tree/Forests are employed.

### Example 1

### Single Cell Analysis

To show the application of ToF-SIMS and PCA to the problem of cancer cell differentiation, we have demonstrated the ability to image and identify individual cells from three human breast cancer cell lines, MCF-7, T47D, and MDA-MB-231. In homogenized cells, we show the ability to differentiate the cell types as well as cellular compartments (cytosol, nuclear and membrane).

Cell Culture. MCF-7, T47D, and MDA-MB-231 human breast cancer cells were obtained and grown according to published conditions.

For cell homogenization experiments, 2×10⁶ cells were plated in T75 flasks and were harvested 48 hr later, when the cells were 75% confluent. For whole cell analysis, 8×10⁵ cells were plated in a 60 mm dish containing 3 to 5 silicon wafers, each about 1 cm square. The Si wafers were sterilized by UV irradiation prior to seeding. Cells were grown on the polished side of the silicon wafers; no change was observed in cellular growth or morphology as compared to cells grown on the typical plastic-cell-culture ware. Cells grown on wafers were freeze-fractured 48 hr after plating.

TOF-SIMS Analysis. The TOF-SIMS measurements were conducted on a PHI TRIFT III instrument (Physical Electronics USA, Eden Prairie, Minn.) equipped with a gallium (⁶⁹Ga⁺) liquid metal ion gun operated at 25 kV. A pulsed low-energy electron gun provided charge neutralization for all samples. Positive ion TOF-SIMS spectra were generally acquired over an area of 100×100 μm. The samples were held at room temperature during the course of the TOF-SIMS measurements. All TOF-SIMS spectra were calibrated to the CH₃_{⁺}, C₂H₃_{⁺}, and C₄H₇_{⁺} peaks before PCA. Five to ten spectra were recorded for each cell homogenate spot. For whole cell analysis, six or seven cells of each cell type showing the exclusion of sodium from the cellular area, which is evidence of fracturing an intact cell, were imaged and the average spectrum encompassing the whole cell was recorded.

Principal Component Analysis. Unit mass binning was applied to each spectrum before further analysis. For cell homogenates and individual cells, m/z=69 (implanted gallium ions) and m/z=73, 147, and 207 (PDMS contamination peaks) were removed from the data set and then masses 58 through 500 were normalized to the total ion count of these masses for each spectrum. All resulting data matrices were mean-centered and reduced by principal component analysis (PCA) using MATLAB software v. 7.0 (MathWorks Inc., Natick, Mass.) along with PLS Toolbox v. 3.5 (Eigenvector Research, Manson, Wash.). The PCA software generates a scores plot to visualize data relationships and a loadings plot to determine masses important for sample differentiation. For the homogenate samples, m/z=72, a strong fragment from the protease inhibitor, was removed from the data set for PCA.

For PCA analysis, six or seven fractured cells of each cell line were imaged and a composite mass spectrum of the entire cellular region was obtained. The scores plot shows a good separation of the MCF-7, MDA-MB-231, and T47D cell spectra, confirming our ability to differentiate cell types. TOF-SIMS spectra taken from the background region near each cell, and treated identically to the cell spectra, failed to separate into groups using PCA data reduction. ToF-SIMS spectra acquired from T47D cells were similar to the MCF-7 cells and not as closely related to the MDA-MB-231 cells. In fact, the ER+MCF-7 and T47D cells, which have a similar non-invasive phenotype, are closely related and well differentiated from the ER−, highly metastatic MDA-MB-231 cells. These data show that dimension reduction techniques such as PCA can create a small number of variables which can capture important differences between tissue types.

### Example 2

### Paraffin-Embedded Mouse Embryo Analysis

Time-of-Flight Secondary Ion Mass Spectrometry (ToF-SIMS) equipped with a gold ion gun was used to image mouse embryos and differentiate tissue types (brain, spinal cord, skull, rib, heart and liver). Embryos were paraffin-embedded and then deparaffinized. The robustness and repeatability of the method was determined by analyzing nine tissue slices from three different embryos over a period of several weeks. Using Principal Component Analysis (PCA) to reduce the spectral data generated by ToF-SIMS, histopathologically identified tissue types of the mouse embryos can be differentiated based on the characteristic differences in their mass spectra. These results demonstrate the ability of ToF-SIMS to determine subtle chemical differences even in fixed histological specimens.

This study extends the analytical capabilities of ToF-SIMS and PCA by imaging and differentiating histopathologically identified tissues from 16 day old FFPE mouse embryos. In this study Applicants demonstrate differentiation of six tissue types and show the reproducibility and robustness of the analysis. These experiments provide the foundation for work with human FFPE tissues and suggest new uses for ToF-SIMS for molecular pathology.

### Examples—Animals

Female C57BL/6BAC mice were purchased from the Jackson Laboratory (Bar Harbor, Me.) and bred with male C57BL/6BAC mice to generate the embryos used in this experiment. The animals were maintained on a 12-hr dark/light cycle in a temperature and humidity controlled room. The care of the animals was in accord with the Lawrence Livermore National Laboratory (LLNL) Institutional Animal Care and Use Committee (IACUC) committee guidelines. Animals are anesthetized with isoflurane and killed through cervical dislocation. Embryos were harvested using standard techniques.

Mouse Embryo Tissue Slice Preparation

Three sixteen-day-old mouse embryos from three different dams designated with the numbers 1 to 3 were fixed in 4% paraformaldehye for 36 hours and embedded in paraffin blocks using standard techniques. Four micron thick saggital slice sections were cut from each embryo using a Leica RM2165 microtome and were designated as sections 1 through 9. A fourth slice was cut from the third embryo and was designated as section 10. The sections were placed on 1.2×1.2 cm silicon (Si) wafer substrates and incubated at 40° C. for overnight. The samples were then deparaffinized and dehydrated using xylene and 100% ethanol. The samples were allowed to air dry and were stored in vacuum at 1E-4 Torr for 24 hours before ToF-SIMS analysis.

A fourth mouse embryo was prepared as described above for optical imaging. A 4 micron section was cut and stained with hematoxylin and eosin (H&E) using standard immunohistochemical techniques. The sample was placed on a glass slide and evaluated by the pathologist, Dr. Lu. The identified tissues in this sample were used as a reference for the ToF-SIMS analysis.

ToF-SIMS Analysis

ToF-SIMS measurements were conducted on a PHI-TRIFT III instrument (Physical Electronics USA, Chanhassen, Minn.) equipped with a gold liquid metal ion gun (Au LMIG). The ion gun was operated at 22 kV and in an unbunched mode. Positive ion SIMS analyses were done utilizing Au+ cluster ions at room temperature, with a pulsed, low-energy electron gun providing charge neutralization. For the tissue differentiation experiment, six tissue types were selected from section number 10: skull, rib, brain, spinal cord, heart and liver. Tissues were identified based on the pathologist's designation of similar tissue regions in the H&E stained section. ToF-SIMS measurements were conducted over a 300×300 μm area for 5 minutes; one average mass spectrum was reconstructed for that specific region of the tissue section. Ten measurements were recorded for each tissue type. The mass spectra were calibrated using common hydrocarbon fragment peaks at CH₃_{⁺}, C₂H₃_{⁺}, and C₄H₇_{⁺}. For the tissue reproducibility experiment, sections 1 through 9 were analyzed. Four tissue types were selected for analysis: brain, rib, heart and liver. Five measurements were recorded for each tissue type. Each of the nine samples was analyzed twice over a period of one month in order to monitor the reproducibility and stability of data. Spectra for background controls were acquired by analyzing clean silicon areas on the wafers. Contamination peaks (m/z=73, 147, 207, 281, 325, 355, 647, 662 etc), attributed to sample handling, were identified from the background control spectra and excluded in the later PCA analysis.

Principal Component Analysis

Principal component analysis (PCA) was used to analyze the spectra and images obtained from the measurements. Specifically, data reduction was accomplished using MATLAB v. 7.0 (MathWorks Inc., Natick, Mass.) along with PLS Toolbox v. 3.5 (Eigenvector Research, Manson, Wash.). Unit mass binning was applied to each spectrum with the exception of m/z=40, which contained only the calcium (Ca) peak. Masses from m/z=60 to 500 and m/z=40 (Ca) were used for data analysis. Identified contamination peaks such as fragments of polydimethylsiloxane (PDMS), m/z=73, 147, 207, were excluded from the PCA data reduction. The resulting spectral dataset was normalized to that spectrum's total ion counts and then mean-centered before PCA. A scores plot with ninety percent data contours and loading plot were then generated. Ninety percent data contours were drawn using the error_ellipse.m code by J. Andrew Johnson of Binghamton University, acquired from the MATLAB Central File Exchange.

Differentiation of Tissue Types by PCA

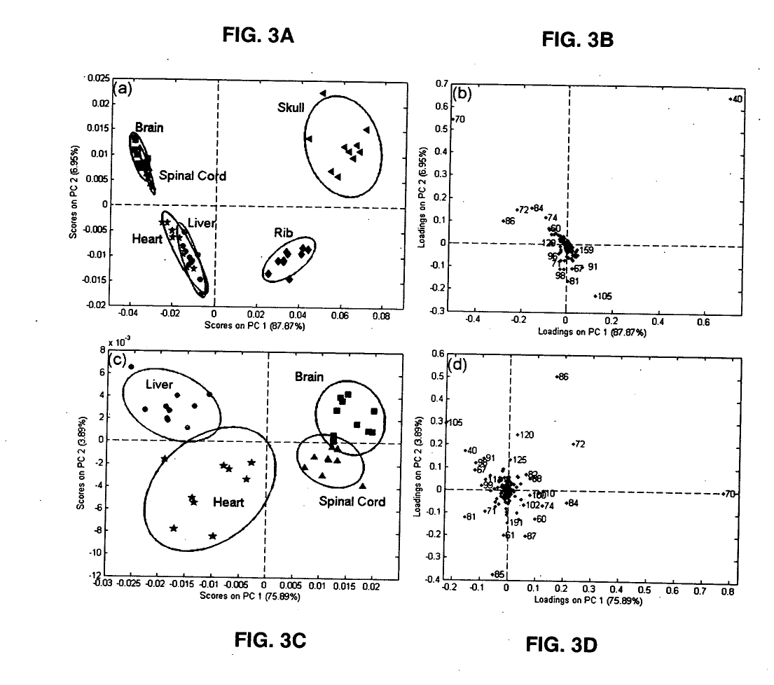

To determine Applicants ability to differentiate tissues using PCA, positive ion mass spectra from 6 different tissues of tissue section number 10 were acquired and analyzed. Ten regions from each brain, spinal cord, skull, rib, heart and liver were converted to spectra and used for the analysis. Low mass peaks (below m/z=60, C₄ and smaller hydrocarbon clusters) were removed from the PCA calculation to exclude these hydrocarbon peaks that carry no specific chemical information. Background peaks were identified and also removed from the analysis. FIG. 3(A) shows the scores plot of the first principal component (PC1) and the second principal component (PC2) axes. Together, these two PCs capture approximately 95% of the variance among the data groups. Each point in the scores plot represents a mass spectrum acquired from one specific tissue area; spectra from different tissue types are denoted by different color symbols. The ellipses surrounding each group represent the 90% data contour for that group. This plot shows that the spectra from each tissue type are tightly clustered and that the tissues are separated according to chemical composition. The bone-derived skull and rib groups, which contain a higher mineral concentration, are well-separated from nervous tissue (brain and spinal cord) and the heart and liver. The corresponding PCA loading plot illustrated in FIG. 3(B) shows that m/z=40 (calcium (Ca)) is the variable primarily responsible for differentiating the skull and rib from the less-mineralized tissues.

Further examination of the scores plot (FIG. 3A), shows that the brain and spinal cord groups exhibit considerable overlap, denoting the similar molecular composition of these two tissue types. Nervous tissue contains a high concentration of phospholipids, primarily from the myelin that surrounds the axons or nerve cells. Although lipids are mostly lost during the tissue fixation process, the chemical information that remains in the molecular matrix that supports the phospholipids is sufficient to clearly differentiate these tissues from the heart and liver spectra. Heart tissue, which is primarily made up of cardiac muscle cells, and liver tissue, which is composed of hepatocytes, contains a higher concentration of cellular protein. These molecular differences produce a different pattern of peaks in the ToF-SIMS spectra that can be differentiated by PCA. Thus, the results seen in the scores plot in FIG. 3 are confirmed by the known biology of the various tissues.

In an effort to extend Applicants ability to separate the soft tissues, Applicants removed the skull and rib spectra from the PCA calculation and repeated the statistical analysis. FIGS. 3(C) and 3(D) show the resulting scores and plots using only the spectra acquired from the brain, spinal cord, heart and liver tissues. Although the scores plot (FIG. 3(C)) shows a slight overlap in the 90% data contours of the brain/spinal cord and heart/liver groups, essentially the four soft tissues are well separated. The nervous tissues, brain and spinal cord, are separated from the heart and liver groups on PC1 and the heart and liver are separated on PC2. Given that the heart and liver are composed of different cell types and have different physiological functions, this is to be expected. More surprisingly, the brain and spinal cord are also separated on PC2. These two tissues, which are part of the central nervous system, are both composed essentially of neurons. The primary anatomical difference between the brain and the spinal cord is the arrangement of the grey and white matter. In the spinal column the grey matter (the neuronal cell bodies) are on the inside and surrounded by white matter (axons, or the fibers that connect the neurons). In the brain's cerebral cortex, the grey matter surrounds the white matter. Depending on the exact location of the section through the embryo, it is possible that the spectra acquired from these two organs differed in the amount of white or grey matter being sampled. It is likely that the chemical composition of the white matter, which is covered by a dense layer of myelin, would be distinctly different from grey matter, which may account for the differences in the spectral patterns. Because the lipids that would be associated with the myelin in these tissues are lost during the fixation process, the differences in the spectral patterns could be a result of differing protein compositions in the grey and white matter. Examining the corresponding loadings plot (FIG. 3(D)) shows that peaks at m/z=70, 72, 84, 86 and 120 are closely related to the brain and spinal cord (which can also be noted in FIG. 3(B)).

Reproducibility and Stability of the ToF-SIMS Method

In order to understand both the reproducibility of the ToF-SIMS method, as well as the chemical stability of the samples, Applicants did repeated measurements of the embryos over the period of one month. These studies are necessary in order to identify potential sources of variation in that may occur during the analysis of paraffin embedded clinical samples. Clinical samples are frequently stored under minimally controlled conditions for extended periods of time and may vary depending upon individual laboratory sample processing procedures. Understanding the reproducibility and stability of the method is essential for future applications of ToF-SIMS to paraffin embedded samples.

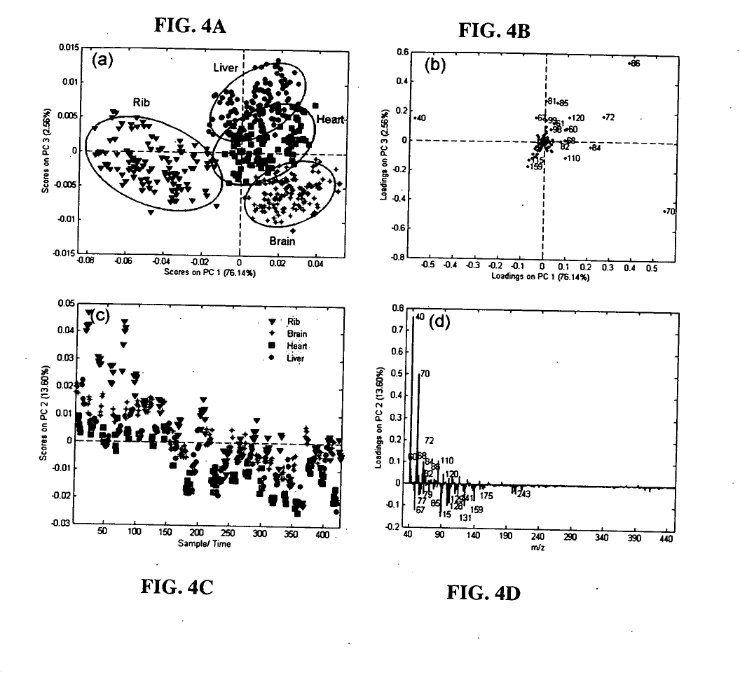

To determine the stability and reproducibility of the experiment, spectra from four tissue types: rib, brain, heart and liver of nine embryo sections, were acquired twice over a period spanning one month. This entire spectral data set (including the corresponding spectra of the differentiating experiment above), composed of 450 spectra, was then analyzed by PCA. FIGS. 4(A) and 4(B) show the scores and loading plots of the first principal component (PC1) and third principal component (PC3) axes. The scores plot, FIG. 4(A), shows a good separation of the four tissue types. The variation within the sample dataset is mainly from three sources: 1) inherent biological variation within the samples, 2) environmental contamination of the sections and 3) changes in the sample during storage. Biological variation is to be expected in these samples; the spectra acquired from the tissues were taken from three embryos that were obtained from three different dams. Although using the same strain of mice for the experiment assures a consistent genetic background among the mice, phenotypic variation among individuals contributes to the sample variation. The second source of variation, environmental contamination, is most frequently demonstrated as differences in the amount of PDMS among the embryos. In this experiment, there was a higher concentration of PDMS in embryos 2 and 3. The PDMS appears to have been introduced into the sample before sectioning and deparaffinization because all of the samples were handled and processed at the same time, under identical conditions. Although the majority of the sample scattering due to PDMS can be removed from the analysis by removal of PDMS-related peaks (m/z=73, 147, 207), differences in the samples due to the matrix effect of PDMS cannot be removed or accounted for and results in variations among the samples.

The third source of variation is change in the samples during storage. In FIG. 4(C) the scores on PC2 are plotted as a function of sample number. In these data increasing sample number is also related to storage time; higher sample numbers correspond to spectra that had been acquired from samples that had been stored longer. Applicants believe that changes seen in the samples along PC2 demonstrate chemical changes in the samples due to storage. The corresponding plot, FIG. 4(D), indicates that over time the samples have a relatively decreased signal intensity for the even number peaks (peaks that commonly represent organic materials) and an increased signal intensity for the odd number peaks (hydrocarbon peaks). Since samples were stored under vacuum, volatile organic compounds could be gradually depleted over time, causing the relative decrease in the even numbered peaks. Comparing background spectra from just the silicon areas of the sample wafers, taken at different times, indicates that there was an increasing intensity of peaks attributed to PDMS as well as some unknown peaks at m/z=647 and 662. These contaminating peaks could have been introduced when the vacuum was released and samples were exposed to air, or they could be contamination from the vacuum system itself, i.e. pump oil. Even through PDMS and other identified contamination peaks are removed from the PCA calculation, the matrix effects from those peaks may also affect the calculation results. These results demonstrate the need for a well-controlled sample storage protocol for future studies.

### Example 3

### ToF-SIMS Analysis of a Bladder Cancer Tissue Section

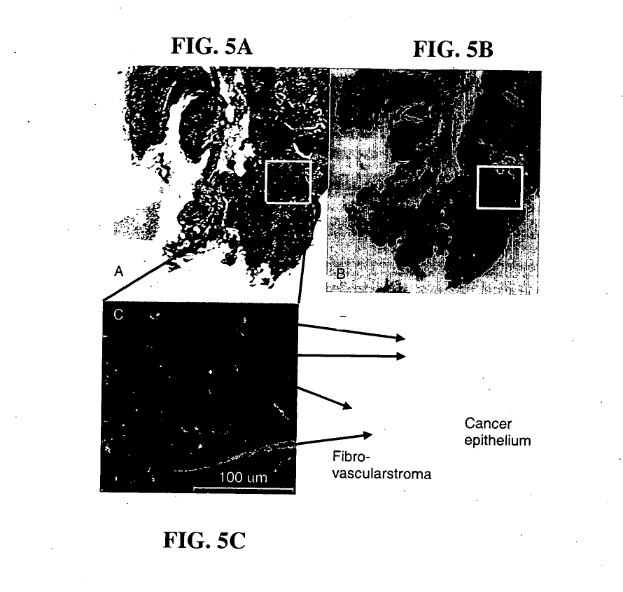

A 4-μm thick bladder cancer tissue section, was placed on a transparent, conductive gold slide, analyzed and compared to an optical image of the H&E stained adjacent tissue section. FIGS. 5A, 5B, and 5C, illustrates how the optical images are used to facilitate localization of the ToF-SIMS images with the H&E stained sections. ToF-SIMS positive ion images (200 μm×200 μm) were obtained for seven areas within the cancer regions of the tissue section. Based on the H&E, optical and ToF-SIMS total ion images, we identified areas of cancer epithelium and of cancer-supporting fibrovascular stroma within the images. FIG. 5C shows a representative ion image containing both cell types. Because the images are composed of a two-dimensional array of mass spectra, we can further extract average mass spectra from selected regions of interest (ROI). In these images, one cancer epithelium and one fibrovascular stroma region of interest were separately selected from each of the seven ToF-SIMS images. These region-specific spectra reflect the chemical composition present in the cancer epithelium and fibrovascular stroma, respectively.

The spectra obtained from the regions of interest were preprocessed by normalizing peaks from m/z=50 to 500 to total ion count after which the resulting data matrix was analyzed using PLSDA. The scores plot of the ROIs from the seven regions shows that cancer epithelium and fibrovascular stroma regions are easily differentiated. These data demonstrate our ability to image and analyze paraffin-embedded bladder cancer sections and to differentiate cancerous epithelium from fibrovascular stroma within a tissue.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A method of analyzing a cell, comprising the steps of:
directing a primary-ion beam of a time-of-flight secondary ion mass spectrometer to the cell,
interrogating at least one region of interest area from the cell and producing data, and
distributing said data in plots indicating measures of similarity.

2. The method of analyzing a cell of claim 1 including obtaining known data and comparing said data with said know data to characterize disease phenotype of the cell and predict disease outcome.

3. The method of analyzing a cell of claim 1 wherein the cell is a formalin-fixed paraffin-embedded (FFPE) tumor sample.

4. The method of analyzing a cell of claim 1 wherein said primary-ion beam of a time-of-flight secondary ion mass spectrometer is a finely focused energetic primary-ion beam of a time-of-flight secondary ion mass spectrometer.

5. The method of analyzing a cell of claim 1 wherein Principal Component Analysis is used for said step of distributing data in plots indicating measures of similarity.

6. The method of analyzing a cell of claim 1 wherein Linear Discriminant Analysis is used for said step of distributing data in plots indicating measures of similarity.

7. The method of analyzing a cell of claim 1 wherein Partial Least Squares Discriminant analysis is used for said step of distributing data in plots indicating measures of similarity.

8. The method of analyzing a cell of claim 1 wherein Hierarchical Clustering is used for said step of distributing data in plots indicating measures of similarity.

9. The method of analyzing a cell of claim 1 wherein Recursive Partitioning is used for said step of distributing data in plots indicating measures of similarity.

10. The method of analyzing a cell of claim 1 wherein Decision Tree/Forests analysis is used for said step of distributing data in plots indicating measures of similarity.

11. A method of analyzing cells, comprising the steps of:
directing a primary-ion beam of a time-of-flight secondary ion mass spectrometer to the cells,
interrogating at least one region of interest area from the cells and producing data, and
distributing said data is in plots indicating measures of similarity.

12. The method of analyzing cells of claim 11 including obtaining known data and comparing said data with said know data to characterize disease phenotype of the cells and predict disease outcome.

13. The method of analyzing cells of claim 11 wherein the cells are formalin-fixed paraffin-embedded (FFPE) tumor samples.

14. The method of analyzing a cell of claim 11 wherein said primary-ion beam of a time-of-flight secondary ion mass spectrometer is a finely focused energetic primary-ion beam of a time-of-flight secondary ion mass spectrometer.

15. The method of analyzing a cell of claim 11 wherein Principal Component Analysis is used for said step of distributing data in plots indicating measures of similarity.

16. The method of analyzing a cell of claim 11 wherein Linear Discriminant Analysis is used for said step of distributing data in plots indicating measures of similarity.

17. The method of analyzing a cell of claim 11 wherein Partial Least Squares Discriminant analysis is used for said step of distributing data in plots indicating measures of similarity.

18. The method of analyzing a cell of claim 11 wherein Hierarchical Clustering is used for said step of distributing data in plots indicating measures of similarity.

19. The method of analyzing a cell of claim 11 wherein Recursive Partitioning is used for said step of distributing data in plots indicating measures of similarity.

20. The method of analyzing a cell of claim 11 wherein Decision Tree/Forests analysis is used for said step of distributing data in plots indicating measures of similarity.

21. A method of analyzing small groups of cells or a single cell with tissues or surrounding materials, comprising the steps of:
a primary-ion beam of a time-of-flight secondary ion mass spectrometer is direct to the small groups of cells or the single cell and tissues or surrounding materials,
at least one region of interest area from individual cells, tissues or surrounding materials is interrogated and data is produced, and
said data is distributed in plots indicating measures of similarity.

22. The method of analyzing small groups of cells or a single cell of claim 21 including obtaining known data and comparing said data with said know data to characterize disease phenotype of the small groups of cells, the single cell, or the tissues or surrounding materials and predict disease outcome.

23. The method of analyzing small groups of cells or a single cell of claim 21 wherein the small groups of cells or a single cell with tissues or surrounding materials are formalin-fixed paraffin-embedded (FFPE) tumor samples.

24. The method of analyzing a cell of claim 21 wherein said primary-ion beam of a time-of-flight secondary ion mass spectrometer is a finely focused energetic primary-ion beam of a time-of-flight secondary ion mass spectrometer.

25. The method of analyzing a cell of claim 21 wherein Principal Component Analysis is used for said step of distributing data in plots indicating measures of similarity.

26. The method of analyzing a cell of claim 21 wherein Linear Discriminant Analysis is used for said step of distributing data in plots indicating measures of similarity.

27. The method of analyzing a cell of claim 21 wherein Partial Least Squares Discriminant analysis is used for said step of distributing data in plots indicating measures of similarity.

28. The method of analyzing a cell of claim 21 wherein Hierarchical Clustering is used for said step of distributing data in plots indicating measures of similarity.

29. The method of analyzing a cell of claim 21 wherein Recursive Partitioning is used for said step of distributing data in plots indicating measures of similarity.

30. The method of analyzing a cell of claim 21 wherein Decision Tree/Forests analysis is used for said step of distributing data in plots indicating measures of similarity.
